(19) United States
(12) Patent Application Publication
(10) Pub. No.: US 2026/0009190 A1
(43) Pub. Date: Jan. 8, 2026

(54) CONSTRUCTION MACHINE

(71) Applicant: Hamm AG, Tirschenreuth (DE)

(72) Inventors: Stefan BÄUML, Tirschenreuth (DE); Tobias FEHR, Mitterteich (DE); Marc VOGTMANN, Höchstädt im Fichtelgebirge (DE)

(21) Appl. No.: 18/762,773

(22) Filed: Jul. 3, 2024

(30) Foreign Application Priority Data
Jul. 7, 2023 (DE) 10 2023 117 922.5

(51) Int. Cl. E01C 19/28; F16C 33/76; F16C 41/00; H01R 35/04

(52) U.S. Cl. CPC E01C 19/286; F16C 33/76; F16C 41/002; H01R 35/04

(57) ABSTRACT

A construction machine, in particular a ground compactor, includes at least one system region which is rotatable about an axis of rotation with respect to a machine frame and at least one first electrical unit on the rotatable system region. The at least one first electrical unit is electrically conductively connected by a line connection to at least one second electrical unit carried outside the rotatable system region with respect to the machine frame. The line connection includes a first line path, wherein the first line path includes at least one sealing arrangement which tightly closes the rotatable system region with respect to a non-rotating system region carried with respect to the machine frame.

The present invention relates to a construction machine, such as a ground compactor, with a system region supported on a machine frame so as to be rotatable about a rotation axis.

Such a construction machine is known from DE 10 2016 121 724 A1. In this construction machine designed as a ground compactor, energy is transmitted wirelessly by induction between an electrical energy consumer arranged in a ground processing drum and an electrical energy source arranged outside the ground processing drum.

It is the object of the present invention to provide a construction machine in which an electrically conductive connection in a rotating system region can be provided in a simple and reliable manner.

According to the invention, this object is achieved by a construction machine, in particular a ground compactor, comprising at least one system region rotatable about an axis of rotation with respect to a machine frame and at least one first electrical unit on the rotatable system region, wherein the at least one first electrical unit is electrically connected by means of a line connection to at least one second electrical unit carried outside the rotatable system region with respect to the machine frame.

The line connection comprises a first line path, wherein the first line path comprises at least one sealing arrangement that tightly seals the rotatable system region with respect to a non-rotating system region carried with respect to the machine frame.

The present invention uses components which are generally present on the construction machine to perform other functions in order to transmit electrical energy or electrical signals between a rotatable system region of a ground processing machine and regions outside this rotatable system region, i.e. a system region which does not rotate with the rotatable system region. Thus, the at least one sealing arrangement primarily ensures that an inner volume of the rotatable system region is sealed off from the outside, so that, for example, the leakage of lubricant can be prevented and the entry of contaminants into this volume region is reliably avoided.

In an advantageous embodiment, the at least one sealing arrangement can comprise a mechanical seal, wherein the mechanical seal comprises a first sliding ring made of electrically conductive material supported with respect to the rotatable system region and a second sliding ring made of electrically conductive material supported with respect to the non-rotating system region, wherein the first sliding ring and the second sliding ring are supported on one another in the direction of the rotation axis so as to be rotatable with respect to one another about the rotation axis. For reasons of stability and durability, the sliding rings are generally made of metal material, such as steel.

In order to ensure a defined positioning of the sliding rings, it is proposed that the first sliding ring is supported by means of a ring-like first sealing element with respect to the rotatable system region radially outward and in a first axial direction, and that the second sliding ring is supported by means of a ring-like second sealing element with respect to the non-rotating system region radially outward and in a second axial direction opposite to the first axial direction.

In order to be able to ensure a tight seal even in the region of the sliding rings supported directly against one another, it can be provided that the first sliding ring has a first axial support region and that the second sliding ring has a second axial support region axially supported on the first axial support region.

For example, to minimize stress, each support region of the first axial support region and the second axial support region may comprise a substantially radially extending support surface.

The first sliding ring and the second sliding ring can be pressed into axial contact with one another by the ring-like first sealing element and the ring-like second sealing element with their first axial support region and second axial support region.

To produce the electrically conductive connection, it is further proposed that the first sliding ring is electrically conductively connected to the at least one first electrical unit by means of a first connecting line, and that the second sliding ring is electrically conductively connected to the at least one second electrical unit by means of a second connecting line. These connecting lines can, for example, be designed in the form of cables, cable rails or the like.

For stable contact, the first connecting line can be electrically connected to the first sliding ring by material connection, preferably soldering, and/or clamping and/or screwing, and/or the second connecting line can be electrically connected to the second sliding ring by material connection, preferably soldering, and/or clamping and/or screwing.

According to an aspect of the present invention which also achieves the object stated at the outset, regardless of the manner in which the first line path is provided, it is further proposed that the line connection comprises a second line path, wherein the second line path comprises at least one bearing unit which supports the rotating system region so as to be rotatable about the axis of rotation with respect to a non-rotating system region carried with respect to the machine frame.

The at least one bearing unit may comprise a rolling element bearing with a bearing outer ring made of electrically conductive material, a bearing inner ring made of electrically conductive material and a plurality of rolling elements made of electrically conductive material supported on the bearing outer ring and the bearing inner ring. Also with such bearing units, it is advantageous for reasons of stability and durability if the various components thereof are made of metal material, e.g. steel.

For electrical contacting, the at least one bearing unit can be electrically connected to the at least one first electrical unit by means of a third connecting line and the at least one bearing unit can be electrically connected to the at least one second electrical unit by means of a fourth connecting line.

In particular, when the second line path provides the ground connection of the construction machine or is to be connected to it, it is advantageous if the third connecting line comprises at least one electrically conductive, supporting structural element of the rotatable system region. The second line path can be provided, at least in part, by components of the rotatable system region that are already present.

For this purpose, it can be provided that the at least one bearing unit is supported radially or axially on at least one electrically conductive, supporting structural element.

For example, it can also be provided that the second line path comprises a drum drive motor in which a rotor region is supported rotatably with respect to a stator region by means of one or more electrically conductive bearing units.

In order to suppress or reduce the transmission of vibrations between the rotatable system region and the machine frame, it is proposed that the non-rotating system region is supported on the machine frame by means of a plurality of elastic, electrically insulating suspension elements.

The at least one first electrical unit can comprise a consumer of electrical energy, preferably a sensor and/or a transmitting unit. Furthermore, it can be provided that the at least one second electrical unit comprises a source of electrical energy, preferably a battery and/or generator.

In particular, when the construction machine is designed as a ground compactor, such as a self-propelled ground compactor, the rotatable system region can comprise a ground processing drum.

By means of the at least one sealing arrangement, a volume in the ground processing drum containing an unbalance arrangement with at least one unbalance mass rotatable about an unbalance axis of rotation can be sealed.

The present invention is described in detail below with reference to the attached figures. In particular:

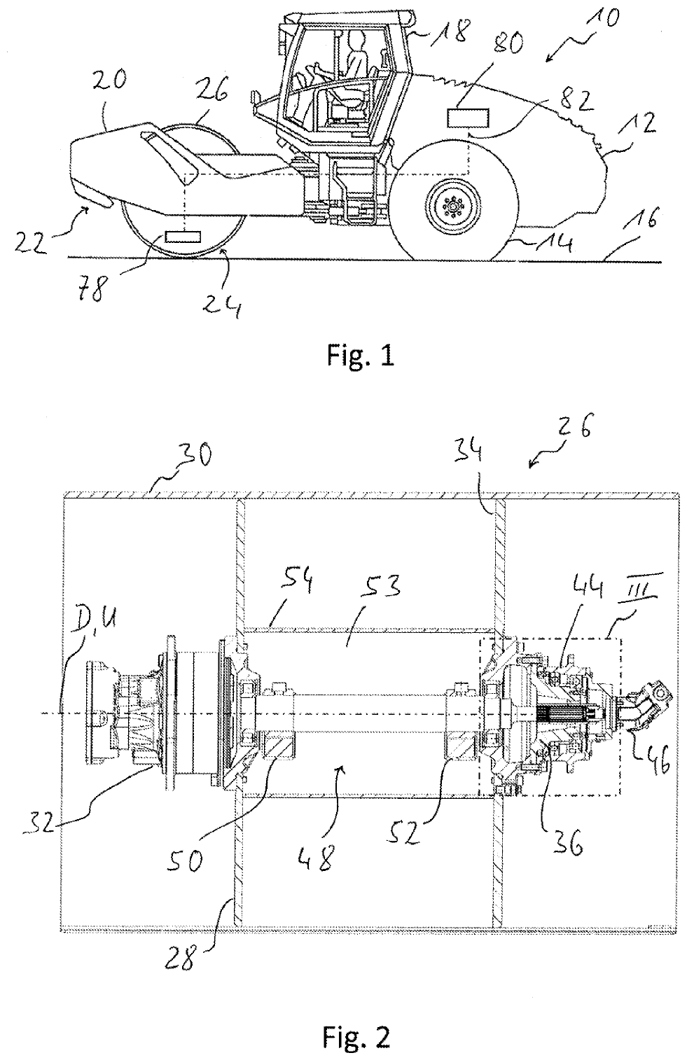

FIG. 1 shows a construction machine designed as a self-propelled ground compactor in side view;

FIG. 2 is a perspective longitudinal sectional view of a ground processing drum of the construction machine of FIG. 1;

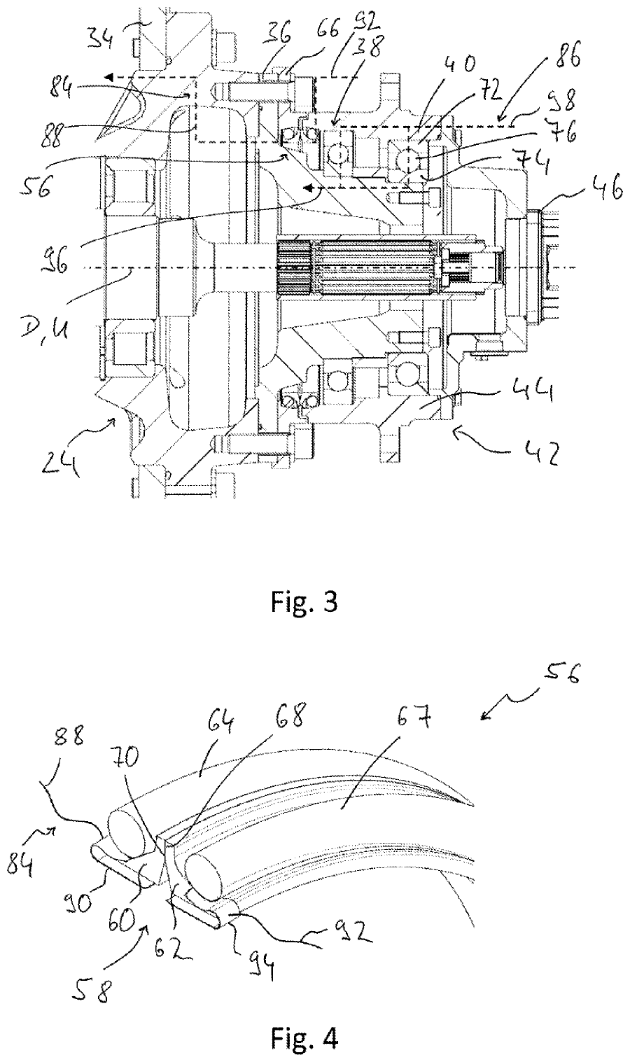

FIG. 3 an enlarged view of detail III in FIG. 2;

FIG. 4 is a perspective sectional view of a mechanical seal of the ground processing drum of the construction machine of FIG. 1.

FIG. 1 shows a side view of a construction machine 10 designed as a self-propelled ground compactor. The construction machine 10 comprises driven wheels 14 on a rear carriage 12, which, driven by a drive unit provided on the rear carriage 12, move the ground processing machine 10 over a ground 16 to be compacted. An operating station 18 is provided on the rear carriage 12, in which an operator operating the ground processing machine 10 can be accommodated.

A front carriage 20 of the ground processing machine 10 is pivotally connected to the rear carriage 12 for steering the same. On the front carriage 20, which essentially provides a component of a machine frame 22 of the ground processing machine 10, a ground processing drum 26, which provides a rotatable system region 24 of the ground processing machine 10, is supported so as to be rotatable about a drum rotation axis D orthogonal to the drawing plane of FIG. 1.

The ground processing drum 26 shown in longitudinal section in FIG. 2 is also driven to rotate in the embodiment shown and for this purpose has a drum drive motor 32 connected to a drum shell 30 via a disk-like carrier element 28, generally also referred to as a disc. A stator region of the drum drive motor 32 may be supported on the front carriage 20 via a plurality of elastic suspension elements (not shown), while a rotor region of the drum drive motor 32 is connected to the support element 28.

A first bearing support element 36, which serves to support the ground processing drum 26 in its end region, which can be seen on the right in FIG. 2, and provides a supporting structural element of the ground processing drum 26, is fixed to a further disk-like carrier element 34, for example by screwing. A second bearing support element 44, which provides one or part of a non-rotating system region 42, is supported on the first bearing support element 36 via two bearing units 38, 40, which can be seen in FIG. 3 and are arranged at an axial distance from one another. The second bearing support element 44 can be supported on the front end 20, for example, by means of a plurality of elastic suspension elements.

An unbalance motor 46 is carried on the second bearing support element 44, which drives an unbalance arrangement 48 arranged in the interior of the ground processing drum 26 for rotation about an unbalance axis U which, in the illustrated embodiment, corresponds to the drum rotation axis D. In the illustrated embodiment, the unbalance arrangement 48 comprises two unbalance masses 50, 52 arranged at an axial distance from one another with a center of mass eccentric to the unbalance axis of rotation U. The volume 53 inside the ground processing drum 26, which essentially contains the unbalance arrangement 48, is enclosed between the two disk-like support elements 34 by a cylindrical housing 54 which is connected to them, for example by welding and is thus also made of metal material and is also enclosed by the first bearing support element 36, in particular at the part visible on the right in FIG. 2.

In order to achieve a tight seal between the first bearing support element 36 and the second bearing support element 44, which rotate relative to one another about the drum rotation axis D during ground processing operation, a sealing arrangement 56 is provided, which can be seen in more detail in FIG. 3 and FIG. 4. The sealing arrangement 56 comprises a mechanical seal 58 with two axially successive sliding rings 60, 62. The first sliding ring 60 is sealed off from the rotatable system region 24, which essentially comprises the ground processing drum 26, by means of a first sealing element 64, for example an O-ring. For this purpose, for example, a sealing element support element 66 is fixed to the first bearing support element 36, on which the first sealing element 64 is supported radially outward with respect to the drum rotation axis D and axially to the left in FIG. 3. Likewise, the first sealing element 64 is supported on the first sliding ring 60 radially inward and axially to the right in FIG. 3.

The second sliding ring 62 is supported with respect to the second bearing support element 44 via an O-ring-like second sealing element 67. The second sealing element 67 is supported radially outward and to the right in FIG. 3 on the second bearing support element 44 and is supported radially inward and to the left in FIG. 3 on the second sliding ring 62.

The two sliding rings 60, 62 are axially supported on one another in the region of a first axial support region 68 of the first sliding ring 60 and a second axial support region 70 of the second sliding ring 62. Each of the two axial support regions 68, 70 can, for example, be provided by a substantially radially extending annular support surface.

Due to the axial preload generated by the two sealing elements 64, 67, the two sliding rings 60, 62, which are supported directly against one another in their axial support regions 68, 70, are axially preloaded against one another so that they produce a tight seal. The entry of contaminants, in particular also into the volume 53, as well as the escape of lubricant from this volume region and from the region of the two bearing units 38, 40 can thus be reliably prevented by the sealing arrangement 56 designed as a mechanical seal 58.

Each of the two bearing units 38, 40 is designed as a rolling element bearing with an outer bearing ring 72 which is supported radially outward and axially with respect to the second bearing support element 44, an inner bearing ring 74 which is supported radially inward and axially with respect to the first bearing support element 36, and a plurality of rolling elements 76, for example balls, acting therebetween or rolling thereon in the circumferential direction. Just like the two sliding rings 60, 62, the bearing rings 72, 74 and also the rolling elements 76 are constructed from metal material, e.g. steel, for reasons of stability and durability.

In FIG. 1 it is illustrated in principle that at least one first electrical unit 78 is arranged in the ground processing drum 26 providing the rotatable system region 24 of the construction machine 10. The electrical unit 78 may, for example, include one or more sensors, such as acceleration sensors, to provide information about the state of motion of the ground processing drum 26. The at least one first electrical unit 78 may alternatively or additionally comprise a transmitting/receiving unit which is designed to transmit and/or receive data in the form of electrical signals.

For example, at least one second electrical unit 80 is provided on the rear carriage 12 of the construction machine 10. The second electrical unit 80 may, for example, comprise a source of electrical energy. For example, the second electrical unit 80 can comprise a rechargeable battery of the construction machine 10, from which the first electrical unit 78 in the ground processing drum 26 is supplied with electrical energy via a schematically illustrated line connection 82. The at least one first electrical unit 80 may alternatively or additionally comprise a transmitting/receiving unit which is designed to transmit and/or receive data in the form of electrical signals.

For example, the structure may be such that the first electrical unit 78 in the ground processing drum 26 is supplied with electrical energy from the second electrical unit 80 via the line connection 82. The information provided by the first electrical unit 78, for example in the form of sensor signals, can be transmitted between the first electrical unit 78 and the second electrical unit 80 or another electrical unit provided for this purpose, for example by radio and/or wirelessly via induction or possibly also via the line connection 82.

In particular, for supplying the first electrical unit 78 with electrical energy from the second electrical unit 80, the line connection 82 comprises two line paths 84, 86, which are indicated in principle in FIG. 3. The first line path 84 can serve, for example, to connect the first electrical unit 78 to the positive pole of the second electrical unit 80 comprising a battery. The second line path 86 can serve to connect the first electrical unit 80 to the negative pole of the second electrical unit 80 comprising a battery or to connect it to the ground connection also comprising the machine frame 22 of the construction machine 10.

In order to guide the first line path 84 in the rotatable system region 24, i.e. the ground processing drum 26, the latter comprises the sealing arrangement 56, which acts as a type of rotary feedthrough. The first sliding ring 60 of the same is electrically connected to the first electrical unit 78 by means of a first connecting line 88 of the first line path 84, which is designed, for example, as a cable. For this purpose, for example, the first connecting line 88 can be firmly connected in an electrically conductive manner to the first sliding ring 60 by means of a clamping element 90. Alternatively or additionally, the first connecting line 88 can be electrically connected to the first sliding ring 60 by screwing or by material bonding, for example soldering.

A second connecting line 92 of the first line path 84, designed for example as a cable, connects the second sliding ring 62 in an electrically conductive manner, for example to the positive pole of the second electrical unit 80 comprising a battery. The second connecting line 92 can be firmly connected to the second sliding ring 62 in an electrically conductive manner by a clamping element 94. Alternatively or additionally, the fixed electrically conductive connection between the second sliding ring 62 and the second connecting line 92 can be made by screwing or material connection, for example soldering.

Since the two sliding rings 60, 62 are made of electrically conductive metal material and are in direct contact with each other, current can flow in the first line path 84 between the two electrical units 78, 80 via the two connecting lines 88, 92 and the two sliding rings 60, 62 of the mechanical seal 58. Since the two sliding rings 60, 62 are only supported with respect to the ground processing drum 26 or the machine frame 22 via the sealing elements 64, 67 interacting with them and thus have no direct contact with other components of the construction machine 10, they are electrically insulated both with respect to the rotatable system region 24 and with respect to the machine frame 22 by the sealing elements 64, 67, which are generally constructed with electrically insulating material. The risk of a short circuit generated via the sliding rings 60, 62 therefore does not exist

The second line path 86, which serves, for example, to establish a ground connection, comprises at least one of the two bearing units 38, 40 as a type of rotary feedthrough. Since the two bearing units 38, 40 are basically constructed with electrically conductive metal material and their inner bearing rings 74 rest on or are supported on the first bearing support element 36 and are thus in electrically conductive contact with it, the first bearing support element 36 can form part of a third connecting line 96 of the second line path 86 as an electrically conductive, supporting structural element of the ground processing drum 26. Other components of the ground processing drum 26, such as the support elements 28, 34 and the housing 54, can also form part of the third connecting line 96 as supporting structural elements of the ground processing drum 26. A negative connection or ground connection of the first electrical unit 78 can thus be connected directly to such a supporting structural element of the ground processing drum 26 and thus electrically conductively to the two bearing units 38, 40 via the third connecting line 96.

A fourth connecting line 98 of the second line path 86 comprises the second bearing support element 44 which supports the two bearing outer rings 72 of the bearing units 38, and is made of metal material. As already explained, for vibration decoupling, the second bearing support element 44 is supported by the front carriage 20 or the machine frame 22 of the construction machine 10, as is the drum drive motor 32 positioned at the other axial end of the ground processing drum 26, via elastic and generally electrically insulating suspension elements. These can be designed, for example, as rubber buffers or the like.

In order to bridge this electrically insulating suspension region, the second line path 86 as part of the fourth connecting line 98 comprises, for example, a cable which is electrically connected to the second bearing support element 44 on the one hand and, for example, the front carriage 20 on the other hand and thus connects the second bearing support element 44 providing the non-rotating system region 42 to the machine frame 22 of the construction machine 10. The machine frame 22, which is generally constructed of metal material, can basically provide the ground region to which the negative pole of the second electrical unit 80 comprising a battery is connected.

The two line paths 84, 86 of the line connection 82 thus comprise, with the sealing arrangement 56 and the two bearing units 38, 44, system regions that act as rotary feedthroughs for the electrical current and that are basically present in such a construction machine 10. Costly and error-prone wireless transmission systems, particularly for feeding electrical energy into the rotatable system region 24, can thus be dispensed with. It should be emphasized again that the line connection 82 comprising the two line paths 84, 86 can alternatively or additionally be used to transmit data or general information from or to the first electrical unit 78.

In particular, the second line path 86, which serves to establish an electrically conductive connection to the ground region of the construction machine 10, can also comprise the drum drive motor 32 as an alternative or in addition to the use of one or both bearing units 38, 40. For example, its stator region can be connected to the front carriage 22 and thus to the machine frame 22 of the construction machine 10 via a cable providing a component of the fourth line path 98, while the rotor region of the drum drive motor 32 in the rotatable system region 24, i.e. the ground processing drum 26, forms a component of the third connecting line 96 coupled to electrically conductive, supporting structural elements thereof. Since the stator region of the drum drive motor 32 is also rotatably coupled to the rotor region thereof via one or more rolling element bearings generally constructed with metal components, such bearing units present in the drum drive motor 32 can also be used as a rotary feedthrough of the second line path 86.

1. A construction machine comprising at least one system region which is rotatable about an axis of rotation with respect to a machine frame and at least one first electrical unit on the rotatable system region, wherein the at least one first electrical unit is electrically conductively connected by a line connection to at least one second electrical unit carried outside the rotatable system region with respect to the machine frame, wherein the line connection comprises a first line path, wherein the first line path comprises at least one sealing arrangement which tightly closes the rotatable system region with respect to a non-rotating system region carried with respect to the machine frame.

2. The construction machine according to claim 1, wherein the at least one sealing arrangement comprises a mechanical seal, wherein the mechanical seal comprises a first sliding ring made of electrically conductive material supported with respect to the rotatable system region and a second sliding ring made of electrically conductive material supported with respect to the non-rotating system region, wherein the first sliding ring and the second sliding ring are supported on one another in the direction of the rotation axis so as to be rotatable with respect to one another about the rotation axis.

3. The construction machine according to claim 2, wherein the first sliding ring is supported by a ring-like first sealing element with respect to the rotatable system region radially outward and in a first axial direction, and in that the second sliding ring is supported by a ring-like second sealing element with respect to the non-rotating system region radially outward and in a second axial direction opposite to the first axial direction.

4. The construction machine according to claim 2, wherein the first sliding ring has a first axial support region, and the second sliding ring has a second axial support region axially supported on the first axial support region.

5. The construction machine according to claim 4, wherein each support region of the first axial support region and the second axial support region comprises a substantially radially extending support surface.

6. The construction machine according to claim 3,
wherein the first sliding ring and the second sliding ring are pressed into axial contact with one another by the ring-like first sealing element and the ring-like second sealing element with their first axial support region and second axial support region.

7. The construction machine according to claim 2,
wherein the first sliding ring is electrically conductively connected to the at least one first electrical unit by a first connecting line, and in that the second sliding ring is electrically conductively connected to the at least one second electrical unit by a second connecting line.

8. The construction machine according to claim 7,
wherein the first connecting line is electrically conductively connected to the first sliding ring by material connection, including soldering, and/or clamping and/or screwing, and/or the second connecting line is electrically conductively connected to the second sliding ring by material connection, including soldering, and/or clamping and/or screwing.

9. The construction machine according to claim 1,
wherein the line connection comprises a second line path, wherein the second line path comprises at least one bearing unit which supports the rotating system region rotatably about the axis of rotation with respect to a non-rotating system region carried with respect to the machine frame.

10. The construction machine according to claim 9,
wherein the at least one bearing unit comprises a rolling element bearing with a bearing outer ring made of electrically conductive material, a bearing inner ring made of electrically conductive material and a plurality of rolling elements made of electrically conductive material supported on the bearing outer ring and the bearing inner ring.

11. The construction machine according to claim 9,
wherein the at least one bearing unit is electrically connected to the at least one first electrical unit by a third connecting line, and the at least one bearing unit is electrically connected to the at least one second electrical unit by a fourth connecting line.

12. The construction machine according to claim 11,
wherein the third connecting line comprises at least one electrically conductive, supporting structural element of the rotatable system region.

13. The construction machine according to claim 12,
wherein the at least one bearing unit is supported radially and/or axially on at least one electrically conductive, supporting structural element.

14. The construction machine according to claim 9,
wherein the second line path comprises a drum drive motor.

15. The construction machine of claim 1,
wherein the non-rotating system region is supported on the machine frame by a plurality of elastic, electrically insulating suspension elements.

16. The construction machine according to claim 1,
wherein the at least one first electrical unit comprises a consumer of electrical energy including a sensor and/or a transmitter unit, and/or the at least one second electrical unit comprises a source of electrical energy including a battery and/or a generator.

17. The construction machine according to claim 1,
wherein the rotatable system region comprises a ground processing drum.

18. The construction machine according to claim 17,
wherein a volume in the ground processing drum containing an unbalance arrangement with at least one unbalance mass rotatable about an unbalance axis of rotation is tightly sealed by the at least one sealing arrangement.
